(19) United States
(12) Patent Application Publication
(10) Pub. No.: US 2023/0315098 A1
(43) Pub. Date: Oct. 5, 2023

(54) Command and Payment Systems and Methods For Self-Driving Robotic Vehicles

(71) Applicant: Rocky Mountain Robotech LLC, Superior, CO (US)

(72) Inventors: Chunbiao GU, Superior, CO (US); Shichao ZHANG, Superior, CO (US)

(21) Appl. No.: 17/856,526

(22) Filed: Jul. 1, 2022

Related U.S. Application Data
(63) Continuation-in-part of application No. 17/710,286, filed on Mar. 31, 2022.

(51) Int. Cl. G05D 1/02; G05D 1/00

(52) U.S. Cl. CPC G05D 1/0212; G05D 1/0088; G05D 2201/0216

(57) ABSTRACT

Systems, methods, and software for managing the work flow of one or more self-driving robotic vehicles (SDRVs), which may be used in restaurant, hotel, warehouse, and other environments, are described. The SDRV systems and methods support SDRV-customer interactions, such as ordering and payment interactions, and, in some embodiments, the SDRVs are able to generate, accept, and/or alter tasks within a task queue based on real-time business activities and changing customer needs.

### CROSS-REFERENCE TO RELATED APPLICATIONS

This application claims the benefit of and priority to U.S. patent application Ser. No. 17/710,286, filed Mar. 31, 2022, which is hereby incorporated by reference in its entirety.

### STATEMENT REGARDING FEDERALLY SPONSORED RESEARCH

None.

### BACKGROUND

Self-driving robotic vehicles are being used in warehouses to perform tasks, such as moving pallets of goods. Typically, a central controller monitors the status of all tasks for a warehouse in a database and, when necessary, instructs a robotic vehicle to move to a specified location and complete an assigned task. The robotic vehicles may be equipped with sensors that allow them to avoid running into infrastructure, other robotic vehicles, and humans, but the robotic vehicles do not purposely interact with or take instructions directly from humans. Nor do the robotic vehicles have the ability to add, delete, or change entries within the database.

### SUMMARY

The present systems and methods relate to self-driving robotic vehicles (SDRVs) that interact with humans to ascertain and serve the humans' needs. The SDRVs are components operating within systems disclosed herein to carry out methods for efficiently serving customers and, optionally, collecting payment therefrom.

Throughout this document, the SDRVs are described as hosts, servers, food runners, and/or cashiers in a restaurant environment. However, the systems and methods can be adapted for use in other settings, and nothing herein is intended to limit the present disclosure to restaurant services.

Some systems and methods disclosed herein allow SDRVs to perform a monitoring function, where an SDRV visits one or more customer locations to ascertain customer needs, essentially seeking a task to be performed by itself or another SDRV. In an aspect, a method for identifying and scheduling tasks associated with customer needs comprises receiving, at a self-driving robotic vehicle (SDRV), instructions to physically move to a customer location and to inquire at the customer location about customer needs and, in response to the inquiry, the SDRV adds one or more tasks associated with goods or services required to meet the customer needs to a task queue. In an embodiment, the SDRV performs at least one of the tasks added to the queue and/or another SDRV performs at least one of the tasks added to the queue.

Adding the one or more tasks to the task queue may be accomplished, for example, when the SDRV transmits a signal encoding the one or more tasks to a centralized controller comprising the task queue or to cloud storage comprising the task queue and/or when the SDRV stores the one or more tasks locally in a local task queue. In an embodiment, the one or more tasks added to the task queue may be prioritized within the task queue by the SDRV or a processor of the controller executing scheduling software.

In an embodiment, the step of inquiring at the customer location about customer needs comprises one or more of the SDRV presenting a visual message or a video message, the SDRV presenting an audio message, and the SDRV visually inspecting the customer location.

In an embodiment, a method may further comprise adjusting timing for subsequently scheduled tasks associated with the customer location when one or more tasks corresponding to a customer need are added to the task queue. For example, adjusting the timing for the subsequently scheduled tasks may comprise: (i) delaying some or all of the subsequently scheduled tasks by an equal amount of time; (ii) canceling one or more of the subsequently scheduled tasks; (iii) expediting one or more of the subsequently scheduled tasks; (iv) coordinating one or more of the subsequently scheduled tasks to coincide with timing of one of the tasks corresponding to the customer needs; or (iv) a combination of (i)-(iv).

In an aspect, a method of collecting payment from a customer using a self-driving robotic vehicle (SDRV) comprises instructing an SDRV to physically move to a customer location and to display payment options for an electronic funds transfer. For example, the payment options may include one or more of a bar code, a QR code, a keypad, a near field infrared receiver, a magnetic strip reader, and a URL address for a payment portal.

In an embodiment, a method of collecting payment from a customer further comprises instructing the SDRV to physically move away from the customer location after receipt of the electronic funds transfer is confirmed.

In an aspect, a method for forecasting and scheduling tasks for completion by a self-driving robotic vehicle comprises: obtaining historical frequency data for a first task performed repeatedly at a specified service location, wherein the first task occurs sporadically; calculating a first time interval between first task occurrences or a mean first task rate using the historical frequency data; determining an amount of time required for a self-driving robotic vehicle (SDRV) to complete the first task; and when the amount of time required for the SDRV to complete the first task is less than the time interval between the first task occurrences, scheduling the SDRV to perform the first task at least as frequently as the time interval between the first task occurrences.

In an embodiment, the time interval between the first task occurrences is determined from a Poisson function.

In an embodiment, a method for forecasting and scheduling tasks further comprises determining a second time interval between completion of the first task and a start of a second task, the completion of the first task and the start of the second task being dependent upon one another.

In an embodiment, an amount of time required to perform the second task depends upon a quantity associated with the first task. For example, the quantity associated with the first task may be a number of guests in a party or a number of items in an order, where an amount of time required to take or deliver orders is directly proportional to the size of the party or the size of the order.

In an embodiment, a method for forecasting and scheduling tasks further comprises steps within a method for identifying and scheduling tasks associated with customer needs described herein.

In an embodiment, a method for forecasting and scheduling tasks further comprises determining that a value of the first task has reached a threshold and calculating an expected time, based on scheduled tasks within a task queue, when the value of the first task will fall below the threshold. For example, a value of the first task may reach a threshold when all tables within a restaurant are full, and an expected wait time for additional guests may be calculated based on tasks remaining for a given customer location/table in the task queue.

In an aspect, a system for carrying out one or more of the methods disclosed herein comprises: one or more self-driving robotic vehicles (SDRVs) that provides at least one good/item or service at a customer location to meet a customer need, a task queue stored in a memory device, and a processor in communication with the task queue and the SDRV, wherein the processor executes instructions for identifying and scheduling tasks associated with customer needs, collecting payment from a customer, and/or forecasting and scheduling tasks. In an embodiment, the memory device and/or the processor is/are disposed within a centralized controller, within an SDRV, or both.

### BRIEF DESCRIPTION OF THE DRAWINGS

Illustrative embodiments of the present invention are described in detail below with reference to the attached drawings, wherein:

FIG. 1 is a schematic showing exemplary components of systems for performing the methods disclosed herein;

FIG. 2 is a flowchart showing steps in a method for identifying and scheduling tasks associated with customer needs, according to an embodiment;

FIG. 3 is a flowchart showing steps in a method for collecting payment from a customer using a self-driving robotic vehicle, according to an embodiment;

FIG. 4 is a flowchart showing steps in a method for forecasting and scheduling tasks for completion by a self-driving robotic vehicle, according to an embodiment;

FIG. 5 is a graph of historical frequency data for a first task performed repeatedly at a specified service location; and

FIG. 6 shows steps for coordinating the delivery of goods by a self-driving robotic vehicle, according to an embodiment.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

As used herein, a “self-driving robotic vehicle (SDRV)” is a vehicle capable of navigating routes through the use of onboard sensors that detect exogenous navigation markers or other objects within the surroundings. For example, an SDRV may contain one or more infrared, near field, or radio sensors, cameras, or other detection devices that capture data from navigation markers or other surroundings. The data or images are then analyzed by a local or remote computer processor to determine what action the SDRV should perform (e.g., stop, turn, reverse, etc.), and the processor sends instructions for carrying out the action to motive components of the SDRV. The motive components then perform the action—all without human supervision.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third object).

As used herein, the terms “processor” and “computer” and related terms, e.g., “processing device”, “computing device”, and “controller” are not limited to just those integrated circuits referred to in the art as a computer, but broadly refer to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

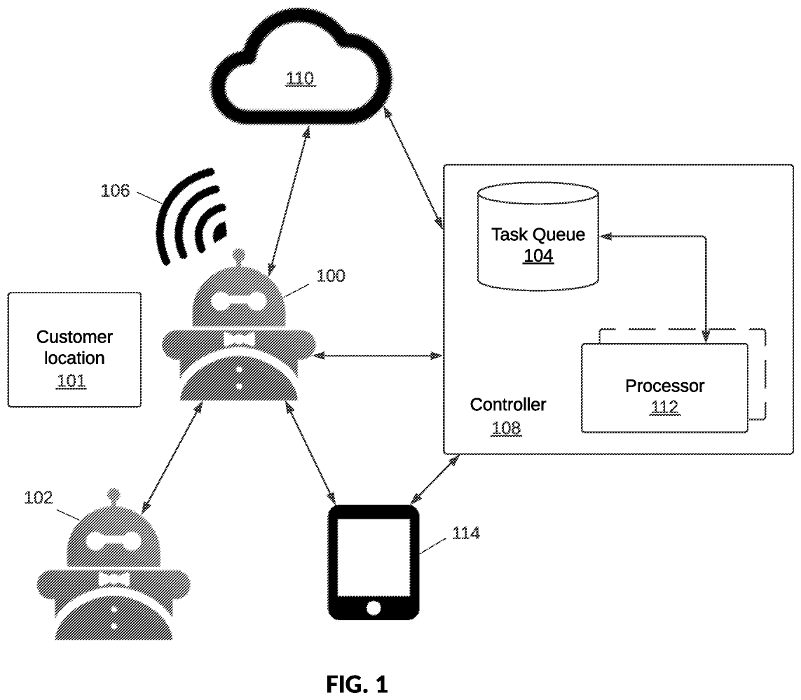

Exemplary systems and methods relating to SDRVs that interact with customers to identify customer needs, then schedule tasks and/or perform tasks to meet the customer needs can be seen in FIGS. 1-6. Multiple items within a figure may not be labeled for clarity.

FIG. 1 is a schematic showing exemplary components of systems for performing the methods disclosed herein. An SDRV 100 physically moves to a customer location 101 to interact with customers (typically, humans). At the customer location, the SDRV inquires about the customers' needs. For example, the SDRV may present a video/visual message, produce an audio message, and/or visually inspect the customer location. If the inquiry produces an affirmative customer need, the SDRV may attend to the need itself, e.g., by adding a task corresponding to the customer need to a local task queue and then performing the task; it may communicate the task to another SDRV 102; and/or it may add a task corresponding to the customer need to a remote task queue 104. If the task is communicated to the other SDRV 102, e.g., via wireless signals 106, the system may have the other SDRV 102 configured to accept all tasks communicated by one or more SDRVs, to accept all tasks of a particular type, and/or to allow the other SDRV 102 to accept or reject the task based on its busy/idle status and send an acceptance or rejection notice to the originating SDRV 100. If the task is rejected, the originating SDRV 100 may perform the task itself or add the task to the remote task queue 104, which may be stored in a database of an onsite controller 108 or offsite, e.g., in cloud storage 110. In either case, the database will be accessible by a processor 112. In some embodiments, the SDRV 100 immediately adds the task to the task queue 104, e.g., by transmitting a signal encoding the task through wireless signals 106 or a wired connection, without assigning the task to any SDRV. In addition, human servers or administrators may add tasks to the task queue and/or instruct an SDRV to perform a task, e.g., using a software application on a client device 114 such as a tablet or phone.

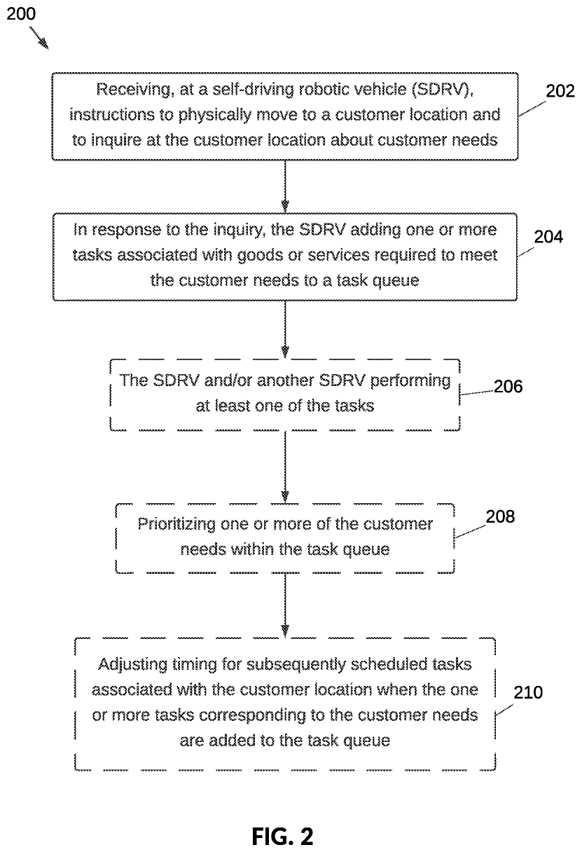

FIG. 2 is a flowchart 200 showing steps in exemplary methods for identifying and scheduling tasks associated with customer needs. In step 202, instructions to physically move to a customer location and to inquire at the customer location about customer needs are received at an SDRV. Responses to the inquiry trigger the SDRV to add one or more tasks associated with goods or services required to meet the customer needs to a task queue in step 204. The task(s) is/are then performed by the originating SDRV and/or another SDRV in optional step 206. In further optional step 208, the SDRV or a human operating a client device may prioritize one or more of the customer needs within the task queue. The timing of subsequently scheduled tasks associated with the customer location may be adjusted, in step 210, when the one or more tasks corresponding to the customer need(s) are added to the task queue. For example, one, some or all of the subsequently scheduled tasks may be delayed by an equal amount of time; one or more of the subsequently scheduled tasks may be canceled; one or more of the subsequently scheduled tasks may be expedited; and/or one or more of the subsequently scheduled tasks may be adjusted to coincide with timing of one of the tasks corresponding to the customer need(s).

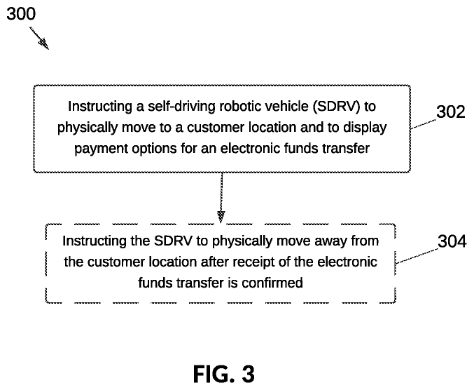

FIG. 3 is a flowchart 300 showing steps in exemplary methods for collecting payment from a customer using a self-driving robotic vehicle. In step 302, an SDRV is instructed to physically move to a customer location and to display payment options for an electronic funds transfer. For example, the payment options may include one or more of a bar code, a QR code, a keypad, a near field infrared receiver, a magnetic strip reader, and a URL address. In optional step 304, the SDRV may be instructed to physically move away from the customer location after receipt of the electronic funds transfer is confirmed.

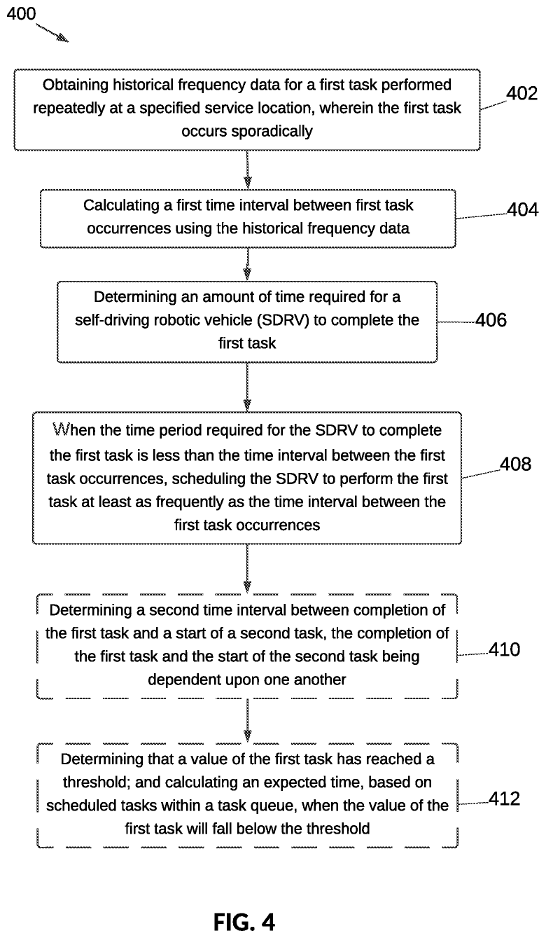

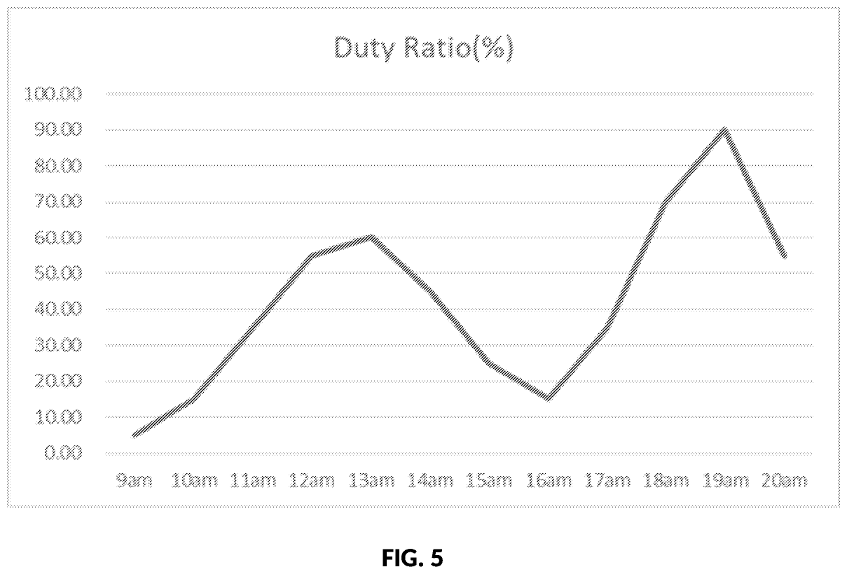

FIG. 4 is a flowchart 400 showing steps in exemplary methods for forecasting and scheduling tasks for completion by a self-driving robotic vehicle. In step 402, historical frequency data, such as that shown in FIG. 5, is obtained for a first task that occurs sporadically and is performed repeatedly at a specified service location, such as a restaurant. In step 404, a first time interval between first task occurrences is calculated using the historical frequency data, and in step 406, an amount of time required for an SDRV to complete the first task is determined. When the amount of time required for the SDRV to complete the first task is less than the time interval between the first task occurrences, the SDRV is scheduled to perform the first task at least as frequently as the time interval between the first task occurrences, in step 408. For example, in a restaurant, new customers arrive repeatedly, but sporadically, and the first task may be performing the host/hostess duties of showing new customers to an open table. Based on historical data, a time interval between customers arriving at the restaurant may be calculated, and an SDRV may check for customers at the host/hostess station at least as frequently as the calculated time interval. In optional step 410, a second time interval between completion of the first task and a start of a second task is determined, where the completion of the first task and the start of the second task are dependent upon one another. For example, in the restaurant, completion of the first task may occur when customers are seated at a table and the start of the second task may be when drinks are ordered. Usually, starting points of the second and subsequent tasks are sequential and the starting points of later steps are dependent upon a completion time of an earlier task. As such, when a preceding task is delayed, the start of one or more subsequent tasks may be adjusted to be delayed by an equal amount of time. Further, an amount of time required to perform a task may depend upon, and be adjusted for, a quantity associated with the first task, such as but not limited to the number of guests in a party or number of items in an order. In addition, an amount of time required to perform a task may depend upon, and be adjusted for, the types of items in an order (e.g., delivery of a birthday cake with singing will require a longer completion time than delivery of a food item without singing). Thus, task scheduling may be based on a combination of historical and real-time data. For example, tasks may be initially generated, sequenced, and scheduled based on historical data, then adjusted based on real-time data. In some embodiments, one or more of the steps of FIG. 2 and/or FIG. 3 may be performed in combination one or more steps of FIG. 4.

Further, optional step 412 includes determining that a value of the first task has reached a threshold and calculating an expected time when the value of the first task will fall below the threshold, based on scheduled tasks within a task queue. In a restaurant environment, step 412 may be implemented, for example, as determining that all dining tables are occupied and no further customers may be seated (i.e., a threshold for the first task has been reached), and calculating the wait time for any table, or a table of a particular size, to become available based on the scheduled tasks within the task queue. In this way, accurate wait times may be provided to customers on a waiting list.

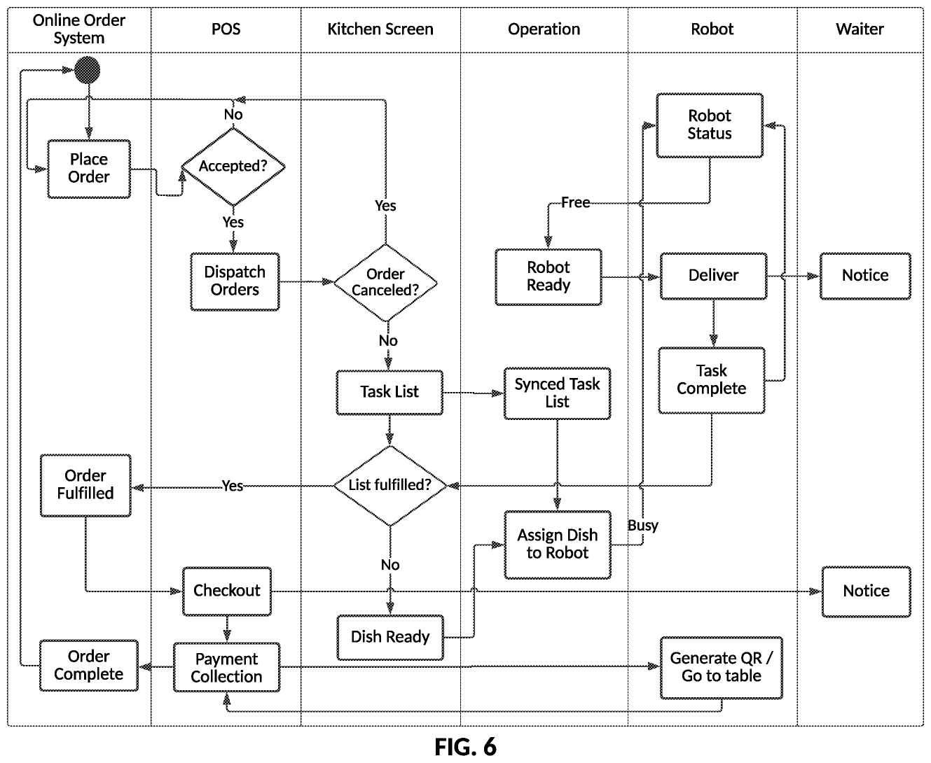

FIG. 6 shows steps for coordinating the delivery of goods by a self-driving robotic vehicle. In the illustrated case, the goods are food being ordered and delivered in a restaurant setting. The process flow shown in FIG. 6 is divided into an online order system, a point of sale (POS), a kitchen screen, an operation system, a robot (SDRV), and a human waiter. The process begins at the circle in the top left corner with an order being placed. A query determines whether the order can be accepted (e.g., is correctly completed). If the answer is “no”, the process reverts to the order placement step. If the answer is “yes”, the order is dispatched through another query asking whether the order has been canceled. If the order has not been canceled, it is assigned to a task list/task queue in the kitchen. If the order has been canceled, the process reverts to the order placement step. Once the order is assigned to the kitchen task list, it is also entered into a synchronized task list/task queue in the operating system or controller. The task list is constantly querying the status of orders/dishes in the task list. Once a dish is ready for delivery, it is assigned to a robot/SDRV, which then reports its status as busy or has its status set to busy as part of the assignment process. The assigned robot retrieves the dish from the kitchen and delivers the dish to the customer. Completion of the delivery task means that the task is complete, the robot status is changed to “free”, a waiter is notified, and the order status is changed to “fulfilled” in the online order system. Changing the order status to “fulfilled” initiates a checkout procedure with payment collection at the point of sale either by a human waiter that is notified of the checkout or by a robot, e.g., via a QR code linked to a currency transfer application. After payment collection, the order status in the online order system is set to “order complete”.

More specific non-limiting information relating to particular calculations and individual software modules is provided below.

Task Forecasting

An initial stage for a specific store/location is defined in the software structure. Using public data or machine learning data from historical tasks, a prediction traffic curve is generated at the beginning of a business cycle.

From a mathematical perspective, the arrival of a customer at a business, such as a restaurant, is a typical Poisson process where:
1. Within any time interval, the probability of a new customer's arrival is stable according to the historical customer visit traffic curve;
2. Which customer visits the business is normally irrelevant; and
3. Customer arrival is a low probability event compared with all people near the business at any moment.

Thus, we can adopt the Poisson formula of Equation (1) to forecast the probability of a customer arriving at a business within a certain time period:

$$P ( N ( t ) = n ) = \frac{{( λ t )}^{n} {e}^{- λ t}}{n !} \qquad Eq . ( 1 )$$

In Eq. (1), P is the probability, N is the forecast function, t is time, and n is customer quantity. For example, in 1 hour the probability of 3 customers arriving is described as P(N(1))=3. λ is the frequency of one event. In a restaurant model, 1/λ can stand for an appropriate time interval for escorting customers to a table.

The probability that two customers arrive within a time interval, T, that is less than or equal to t, can be described as shown in Equation (2).

P(t≤T)=1−e^{-λt} Eq. (2)

Methods disclosed herein calculate these two probabilities to determine a time interval for a robot/SDRV to perform a given task (e.g., return to the host station to escort customers to tables in a restaurant). In this way, a robot will perform the given task (e.g., hosting/escorting) and avoid waiting idle for the given task to be required, as such time can be assigned to other tasks (e.g., food delivery or table cruising to identify customer needs). Thus, business place operation efficiency can be kept at a high level and utilization of an SDRV can be maximized.

As an example, a restaurant's visit data on a certain day of the week is shown in FIG. 5, where the duty ratio relates to a number of occupied tables per total tables and each occupied table is equivalent to one event (λ) and one customer (n). Considering each hour and setting the target probability/confidence interval (P) at 90%, it is possible to determine the time (t) between events using Eq. (1). This type of data may be used to schedule SDRV usage for a particular task when performance of the task is anticipated as being necessary, thereby avoiding extraneous trips and power usage and optimizing productivity.

TABLE 1
Time intervals between events calculated according
to Eq. (1) using hourly historical frequency data.

| | | | | | Calculated | |
|---|---|---|---|---|---|---|
| | | Occupied | | | Time | |
| | Duty | Tables | | Reliability | Interval | Interval |
| Time | Ratio | (n) | Lambda | (%) | (Hour) | (Minutes) |
| 9:00 | 5.00 | 2.00 | 2.00 | 0.90 | 1.151 | 69 |
| 10:00 | 15.00 | 6.00 | 6.00 | 0.90 | 0.384 | 23 |
| 11:00 | 35.00 | 14.00 | 14.00 | 0.90 | 0.164 | 10 |
| 12:00 | 55.00 | 22.00 | 22.00 | 0.90 | 0.105 | 6 |
| 13:00 | 60.00 | 24.00 | 24.00 | 0.90 | 0.096 | 6 |
| 14:00 | 45.00 | 18.00 | 18.00 | 0.90 | 0.128 | 8 |
| 15:00 | 25.00 | 10.00 | 10.00 | 0.90 | 0.230 | 14 |
| 16:00 | 15.00 | 6.00 | 6.00 | 0.90 | 0.384 | 23 |
| 17:00 | 35.00 | 14.00 | 14.00 | 0.90 | 0.164 | 10 |
| 18:00 | 70.00 | 28.00 | 28.00 | 0.90 | 0.082 | 5 |
| 19:00 | 90.00 | 36.00 | 36.00 | 0.90 | 0.064 | 4 |
| 20:00 | 55.00 | 22.00 | 22.00 | 0.90 | 0.105 | 6 |

In a multi tasking system, a processor will calculate time intervals for two or more tasks (e.g., hosting, delivery, cruising, payment, bussing, etc.). In an embodiment, a sequence of tasks will also be taken into consideration. For example, an escorting task will typically be followed by at least one delivery task after a cooking time.

In an embodiment, all tasks generated by the system will be written to a task queue. In an embodiment, after completing its last task, an SDRV will access the task queue and retrieve a task. In another embodiment, a centralized controller will monitor the status of all SDRVs, and schedule tasks for each SDRV.

In an embodiment, a person with access to the system can manually insert, edit, and/or delete tasks. For example, a person with access to the system may be an employee, who is optionally authenticated to the system (e.g., via password, biometrics, proximity, or otherwise). Access to the system may be via a wired connection (e.g., central computer or intranet), or a wireless connection, such as a tablet or mobile device communicating with a centralized or distributed database via the Internet). The tablet or mobile device/client device may utilize an application downloaded (e.g., from the Internet) onto the device configured with an operating system. The APP may be pre-programmed for a particular business or may be set-up to identify customer locations, such as table locations and table numbers, by a user of the device. In an embodiment, the APP may provide notice about SDRV movements.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a processor” includes a plurality of such processors and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements or limitation or limitations which is/are not specifically disclosed herein.

All art-known functional equivalents of materials and methods are intended to be included in this disclosure. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

What is claimed is:

1. A method for identifying and scheduling tasks associated with customer needs comprising:
receiving at a self-driving robotic vehicle (SDRV) instructions to physically move to a customer location and to inquire at the customer location about customer needs; and
in response to the inquiry, the SDRV adding one or more tasks associated with goods or services required to meet the customer needs to a task queue.

2. The method of claim 1 further comprising the SDRV performing at least one of the tasks.

3. The method of claim 2 further comprising another self-driving robotic vehicle (SDRV) performing at least one of the tasks.

4. The method of claim 1 further comprising another self-driving robotic vehicle (SDRV) performing at least one of the tasks.

5. The method of claim 1, wherein adding the one or more tasks to the task queue comprises the SDRV transmitting a signal encoding the one or more tasks to a centralized controller comprising the task queue.

6. The method of claim 1, wherein adding the one or more tasks to the task queue comprises the SDRV storing the one or more tasks locally in the task queue.

7. The method of claim 1 further comprising prioritizing one or more of the customer needs within the task queue.

8. The method of claim 1, wherein the step of inquiring at the customer location about customer needs comprises one or more of presenting a visual message, presenting a video message, presenting an audio message, and visually inspecting the customer location.

9. The method of claim 1 further comprising adjusting timing for subsequently scheduled tasks associated with the customer location when the one or more tasks corresponding to the customer needs are added to the task queue.

10. The method of claim 9, wherein adjusting the timing for the subsequently scheduled tasks comprises:
(i) delaying some or all of the subsequently scheduled tasks by an equal amount of time;
(ii) canceling one or more of the subsequently scheduled tasks;
(iii) expediting one or more of the subsequently scheduled tasks;
(iv) coordinating one or more of the subsequently scheduled tasks to coincide with timing of one of the tasks corresponding to the customer needs; or
(iv) a combination of (i)-(iv).

11. A method of collecting payment from a customer using a self-driving robotic vehicle (SDRV), the method comprising:
instructing a self-driving robotic vehicle (SDRV) to physically move to a customer location and to display payment options for an electronic funds transfer.

12. The method of claim 11, wherein the payment options include one or more of a bar code, a QR code, a keypad, a near field infrared receiver, a magnetic strip reader, and a URL address.

13. A method for forecasting and scheduling tasks for completion by a self-driving robotic vehicle, the method comprising:
obtaining historical frequency data for a first task performed repeatedly at a specified service location, wherein the first task occurs sporadically;
calculating a first time interval between first task occurrences using the historical frequency data;
determining an amount of time required for a self-driving robotic vehicle (SDRV) to complete the first task; and
when the time period required for the SDRV to complete the first task is less than the time interval between the first task occurrences, scheduling the SDRV to perform the first task at least as frequently as the time interval between the first task occurrences.

14. The method of claim 13, wherein the time interval between the first task occurrences is determined from a Poisson function.

15. The method of claim 13 further comprising:
determining a second time interval between completion of the first task and a start of a second task, the completion of the first task and the start of the second task being dependent upon one another.

16. The method of claim 15, wherein an amount of time required to perform the second task depends upon a quantity associated with the first task.

17. The method of claim 13 further comprising:
instructing the SDRV or another SDRV to physically move to a customer location and to inquire at the customer location about customer needs; and
in response to the inquiry, adding one or more tasks associated with goods or services required to meet the customer needs to a task queue.

18. The method of claim 17 further comprising adjusting timing for subsequently scheduled tasks associated with the customer location when the one or more tasks corresponding to the customer needs are added to the task queue.

19. The method of claim 18, wherein adjusting the timing for the subsequently scheduled tasks comprises:
(i) delaying some or all of the subsequently scheduled tasks by an equal amount of time;
(ii) canceling one or more of the subsequently scheduled tasks;
(iii) expediting one or more of the subsequently scheduled tasks;
(iv) coordinating one or more of the subsequently scheduled tasks to coincide with timing of one of the tasks corresponding to the customer needs; or
(iv) a combination of (i)-(iv).

20. The method of claim 13 further comprising:
determining that a value of the first task has reached a threshold; and
calculating an expected time, based on scheduled tasks within a task queue, when the value of the first task will fall below the threshold.
